(19) United States
(12) Patent Application Publication
(10) Pub. No.: US 2026/0019197 A1
(43) Pub. Date: Jan. 15, 2026

(54) WIRELESS COMMUNICATION DEVICE, SYSTEM INFORMATION MESSAGE RECEPTION METHOD THEREOF, AND WIRELESS COMMUNICATION SYSTEM

(71) Applicant: Realtek Semiconductor Corporation, Hsinchu (TW)

(72) Inventor: Jui Peng TSAI, Hsinchu (TW)

(21) Appl. No.: 19/234,286

(22) Filed: Jun. 11, 2025

(30) Foreign Application Priority Data
Jul. 11, 2024 (TW) 113126082

(51) Int. Cl. H04L 1/1812; H04W 72/1273

(52) U.S. Cl. CPC H04L 1/1812; H04W 72/1273

(57) ABSTRACT

A wireless communication device includes a buffer memory and a media access control (MAC) circuit. The MAC circuit is coupled to the buffer memory, and is configured to divide the buffer memory according to system information messages required by the wireless communication device, such that the buffer memory includes hybrid automatic repeat request (HARQ) buffer blocks, and assign HARQ processes for the system information messages required by the wireless communication device, so as to receive the system information message in parallel from a base station in a Narrowband Internet of Things (NB-IoT) downlink scheduling period, in which the HARQ processes respectively correspond to the HARQ buffer blocks.

### RELATED APPLICATIONS

This application claims priority to Taiwan Application Ser. No. 113126082, filed Jul. 11, 2024, which is herein incorporated by reference.

### BACKGROUND

### Technical Field

The present disclosure relates to a wireless communication technology, and more particularly to a wireless communication device, a system information message reception method thereof, and a wireless communication system.

### Description of Related Art

In a wireless communication network, a user equipment needs to receive multiple system information messages from a base station in some cases, and uses the content in the system information messages to register a network where the base station is located. However, according to the current Narrowband Internet of Things (NB-IoT) communication specifications, the previous system information message has to be successfully received for continuously receiving the next system information message. In an environment such as a weak signal environment or an environment in which the base station has a larger cover range, the time consumed to successfully receive all system information messages may be significantly prolonged due to repeated receptions of the system information messages, resulting in a delay for the user equipment to register the network. Therefore, how to speed up the user equipment to register the network in the above environment is one of the main goals in the related industries.

### SUMMARY

The present disclosures provides a wireless communication device which includes a buffer memory and a media access control (MAC) circuit. The MAC circuit is coupled to the buffer memory, and is configured to divide the buffer memory according to system information messages required by the wireless communication device, such that the buffer memory includes hybrid automatic repeat request (HARQ) buffer blocks. The MAC circuit is also configured to allocate HARQ processes for the system information messages required by the wireless communication device, so as to receive the system information messages in parallel from a base station in an NB-IoT downlink scheduling period, in which the processes respectively correspond to the HARQ buffer blocks.

The present disclosure further provides a system information message reception method which is adapted to a wireless communication device and includes: dividing a buffer memory of the wireless communication device according to system information messages required by the wireless communication device, such that the buffer memory includes HARQ buffer blocks; allocating HARQ processes for the system information messages required by the wireless communication device, the HARQ processes respectively corresponding to the HARQ buffer blocks; and receiving the system information messages in parallel from a base station in an NB-IoT downlink scheduling period.

The present disclosure yet provides a wireless communication system which includes a base station and a user equipment (UE). The UE is configured to divide a buffer memory according to required system information messages, such that the buffer memory includes HARQ buffer blocks. The UE is further configured to allocate HARQ processes for the required system information messages, so as to receive required system information messages in parallel from the base station in an NB-IoT downlink scheduling period, in which the HARQ processes respectively correspond to the HARQ buffer blocks.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of a wireless communication system in accordance with some embodiments of the present disclosure.

FIG. 2 is an example of a message sequence chart in which the UE in the wireless communication system in FIG. 1 performs a system information acquisition procedure.

FIG. 3 illustrates a mapping of downlink logical channels, downlink transport channels, and downlink physical channels in NB-IoT.

FIG. 4 is an example of NB-IoT downlink scheduling.

FIG. 5 is a functional block diagram of a wireless communication device in accordance with some embodiments of the present disclosure.

FIG. 6 is a flowchart of a system information message reception method in accordance with some embodiments of the present disclosure.

### DETAILED DESCRIPTION

The detailed explanation of the disclosure is described as following. The described preferred embodiments are presented for purposes of illustrations and description, and they are not intended to limit the scope of the disclosure.

In the context, the master information block-narrowband (MIB-NB, or denoted as MasterInformationBlock-NB) message is referred to as a MIB-NB message; the system information block type 1-narrowband (SIB1-NB, or denoted as SystemInformationBlockType1-NB) message is referred to as a SIB1-NB message, and the system information block type 2-narrowband (SIB2-NB, or denoted as SystemInformationBlockType2-NB) message is referred to as a SIB2-NB message, and so on.

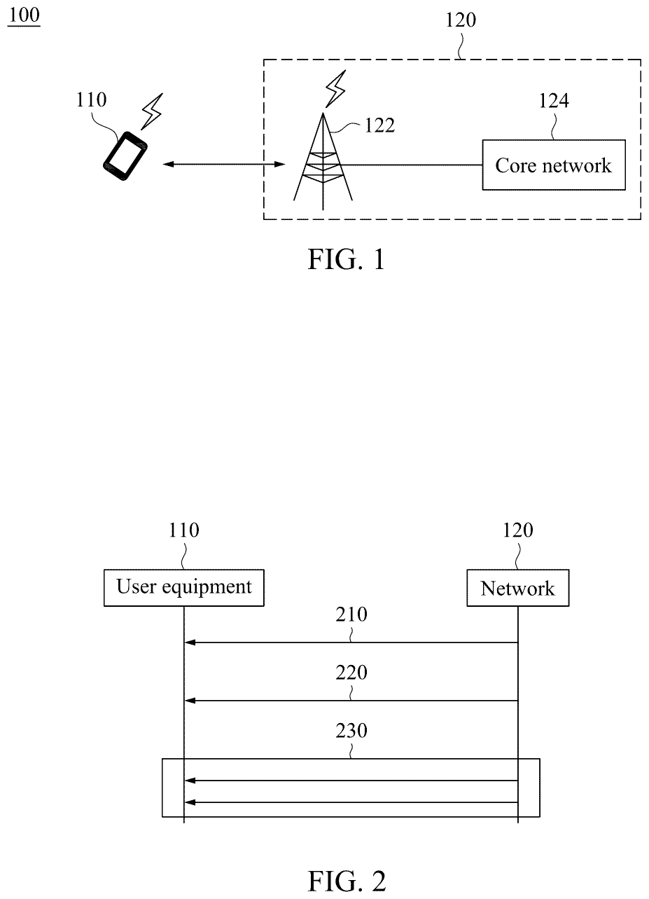

FIG. 1 is a schematic diagram of a wireless communication system 100 in accordance with some embodiments of the present disclosure. The wireless communication system 100 supports NB-IoT communication technologies, and may support, for example, Long Term Evolution (LTE), Fifth Generation (5G) New Radio (NR), Beyond 5G (B5G), and/or other similar wireless communication technologies (such as evolution of any of the aforementioned communication technologies). In the wireless communication system 100, a user equipment (UE) 110 is communicatively connected to a network 120 through a radio access network. The network 120 includes a base station 122 and a core network 124, in which the base station 122 is configured to provide interface(s) for the UE 110 to access the radio access network, and the core network 124 is configured to provide network services for each UE 110, and includes various core network functions. In an example in which the wireless communication system 100 simultaneously supports 5G NR communication technologies, the base station 122 may be, for example, a Next Generation NodeB (gNB), an Evolved Universal Terrestrial Radio Access Network (E-UTRAN) Evolved NodeB (eNB), or a Next Generation Evolved NodeB (ng-eNB). The radio access network may be referred to as a Next Generation Radio Access Network (NG-RAN) or an E-UTRAN that supports 5G functions. The core network 124 is also referred to as a 5G Core (5GC) or a Fourth Generation (4G) Evolved Packet Core (EPC) network that supports 5G functions.

FIG. 2 is an example of a message sequence chart in which the UE 110 performs a system information acquisition procedure. Under a condition, for example, cell selection (such as being performed at startup of the UE 110), cell re-selection, or receiving a notification that the system information has changed, the UE 110 performs a system information acquisition procedure, so as to obtain required system information from the network 120 (i.e., from the base station 122), including a MIB-NB message 210, a SIB1-NB message 220, and/or system information message(s) 230. The MIB-NB message 210 includes main system parameters, parameters related to transmission of the SIB1-NB message 220, and scheduling information of the SIB1-NB message 220. The SIB1-NB message 220 includes cell access related information, cell selection information, and scheduling information of another element(s). In particular, the SIB1-NB message 220 includes a system information value tag for indicating whether the system information message changes, and the UE 110 may use the system information value tag in the SIB1-NB message 220 to verify if the previously stored system information message is still valid. If the previously stored system information messages are invalid, the UE 110 must receive the system information messages (i.e., the subsequently received system information messages shown in FIG. 2) again.

The system information message(s) 230 may include at least one of a SIB2-NB message, a SIB3-NB message, a SIB4-NB message, a SIB5-NB message, and a SIB22-NB message, in which the SIB2-NB message includes radio resource allocation information for all UEs, the SIB3-NB message includes cell re-selection information, the SIB4-NB message includes intra-frequency neighboring cell-related information, the SIB5-NB message includes inter-frequency neighboring cell-related information, and the SIB22-NB message includes radio resource allocation information for paging and random access on non-anchor carriers. The network 120 may broadcast the MIB-NB message 210 on the narrowband physical broadcast channel (NPBCH), and/or may transmit the SIB1-NB message 220 and the system information message(s) 230 to the UE 110 on the narrowband physical download shared channel (NPDSCH).

In some embodiments, the system information message(s) 230 includes a SIB2-NB message. In various embodiments, the system information message(s) 230 may further include a SIB3-NB message, a SIB4-NB message, a SIB5-NB message, and/or a SIB22-NB message, but is not limited thereto. Specifically, when the UE 110 is in the RRC_IDLE state, in addition to the MIB-NB message 210 and the SIB1-NB message 220, the required system information messages for the UE 110 further include a SIB2-NB message and, according to the content of the SIB1-NB message 220, the UE 110 may obtain that the system information message(s) 230 transmitted by the network 120 includes a SIB2-NB message and possibly in addition to a SIB3-NB message, a SIB4-NB message, a SIB5-NB message, and/or a SIB22-NB message. Therefore, when the UE 110 is in the RRC_IDLE mode, the system information messages received from the network 120 shall include at least the MIB-NB message 210, the SIB1-NB message 220, and a SIB2-NB message, and may include a SIB3-NB message, a SIB4-NB message, a SIB5-NB message, and/or a SIB22-NB message. When the UE 110 is in the RRC_CONNECTED state, in addition to the MIB-NB message 210 and the SIB1-NB message 220, the system information messages required for the UE 110 further include a SIB2-NB message, and according to the content of the SIB1-NB message 220, the UE 110 may obtain that the system information message(s) 230 transmitted by the network 120 includes a SIB2-NB message and possibly in addition to a SIB22-NB message. Therefore, in a scenario in which the UE 110 enters from the RRC_IDLE state into the RRC_CONNECTED state, the system information messages received from the network 120 shall include at least the MIB-NB message 210, the SIB1-NB message 220, and a SIB2-NB massage, and may include a SIB22-NB message.

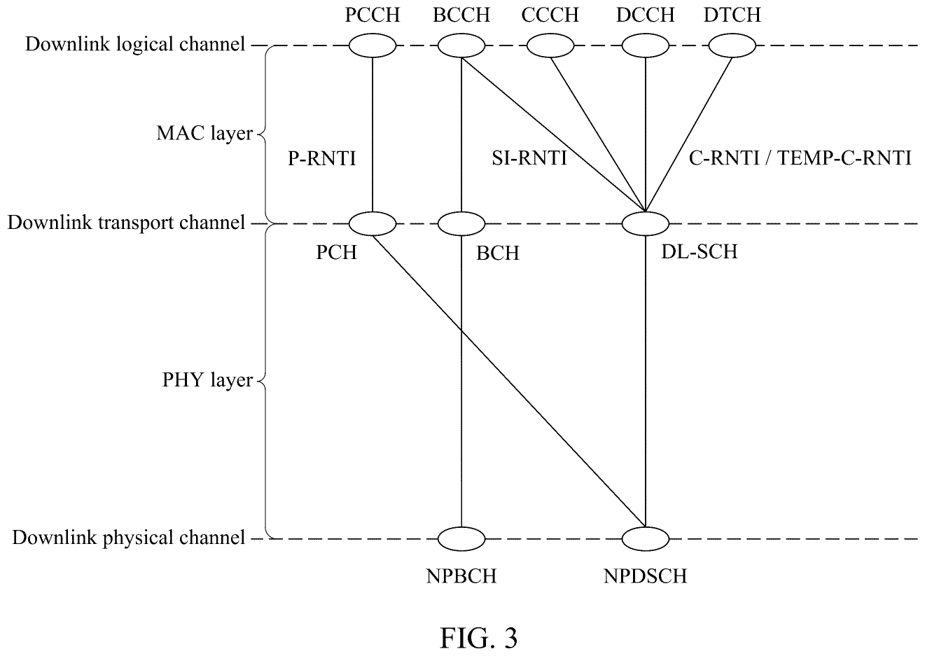

FIG. 3 illustrates a mapping of downlink logical channels, downlink transport channels, and downlink physical channels in NB-IoT. As shown in FIG. 3, the MAC layer may provide a user plane service such as data transmission and a control plane service such as radio resource allocation for the radio link control (RLC) layer on the downlink logical channels, including a paging control channel (PCCH), a broadcast control channel (BCCH), a common control channel (CCCH), a dedicated control channel (DCCH), and a dedicated traffic channel (DTCH), in which the PCCH is used for carrying transmission signals, the BCCH is used for broadcasting system control information, the CCCH is used for transmitting control information between a network and a UE when a radio resource control (RRC) connection is not established, the DCCH is used for transmitting dedicated control information between a network and a UE when an RRC connection is established, and the DTCH is used for transmitting user information dedicated to a particular UE. The downlink transport channels are between the MAC layer and the physical (PHY) layer, which includes a paging channel (PCH), a broadcast channel (BCH), and a download shared channel (DL-SCH), in which the PCH maps to the PCCH, the BCH maps to the BCCH, and the DL-SCH may map to a broadcast control channel, a shared control channel, a dedicated control channel, and/or a dedicated traffic channel. The PHY layer transmits user plane messages and control plane messages to the air interface through the NPBCH and the NPDSCH, in which the NPBCH maps to the BCH, and the NPDSCH maps to the PCH and the DL-SCH.

The base station 122 uses a radio network temporary identifier (RNTI) as the identifier for identifying a UE in the radio access network. The RNTI shown in FIG. 3 includes a paging RNTI (P-RNTI), a system information RNTI (SI-RNTI), a cell RNTI (C-RNTI), and a temporary C-RNTI (TEMP-C-RNTI), in which the P-RNTI is used for paging notification and system information change notification, the SI-RNTI is used for system information broadcasting, the C-RNTI is used for dynamically scheduled unicast transmission, and the TEMP-C-RNTI is used for contention resolution when no valid C-RNTI is available.

For the system information acquisition procedure shown in FIG. 2, the base station 122 may perform operations of cyclic redundancy check (CRC) attachment, channel coding, and rate matching for broadcasting the MIB-NB message 210, the SIB1-NB message 220, and the system information message(s) 230. In detail, when transmitting the MIB-NB message 210, the BCCH maps to the BCH and the NPBCH, and the base station 122 performs code block CRC attachment, channel coding, and rate matching on the MIB-NB message 210. When the SIB1-NB message 220 and the system information message(s) 230 are transmitted, the BCCH maps to the DL-SCH and the NPDSCH, and the base station 122 performs code block segmentation, code block CRC attachment, channel coding, and rate matching on the SIB1-NB message 220 and the system information message(s) 230, and uses the SI-RNTI for system information broadcasting.

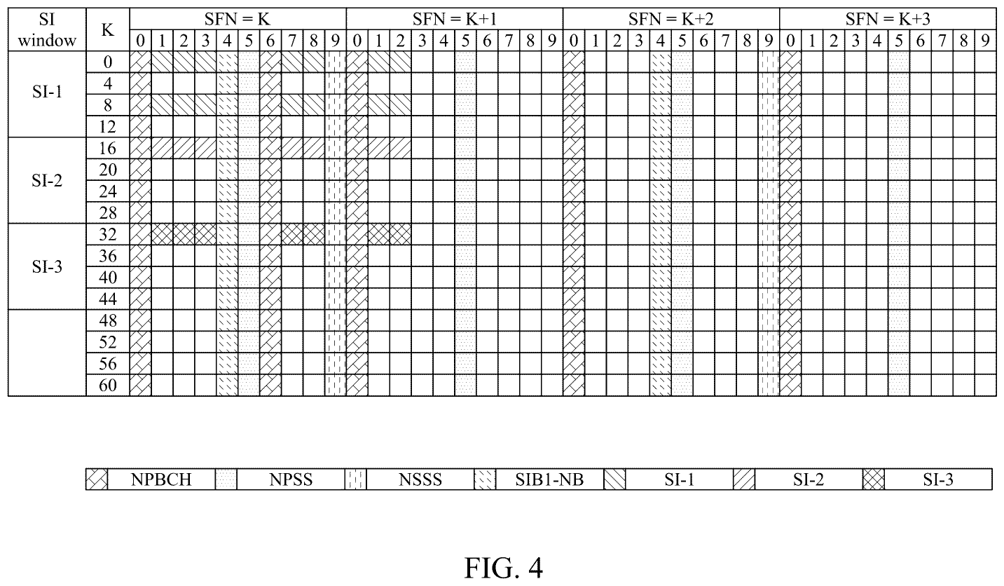

FIG. 4 is an example of NB-IoT downlink scheduling. The NB-IoT downlink scheduling shown in FIG. 4 is a configuration of SIB1-NB message transmission for 16 repetitions, which has a period of 2560 milliseconds (i.e., 256 radio frames) and includes a narrowband primary synchronization signal (NPSS), a narrowband secondary synchronization signal (NSSS), and message transmissions on the NPBCH and the NPDSCH. In FIG. 4, “SFN” represents system frame number, each radio frame includes 10 subframes represented as 0 to 9, respectively, “SI window” represents types of scheduled system information messages including the system information messages SI-1, SI-2, and SI-3, and the window size of each of the system information messages SI-1, SI-2, and SI-3 is 160 subframes (i.e., 16 radio frames). In this example, the system information message SI-1 may be a SIB2-NB message, the system information message SI-2 may be a SIB3-NB message, and the system information message SI-3 may be a SIB4-NB message or a SIB5-NB message, but the present disclosure is not limited thereto.

As shown in FIG. 4, the NPBCH occupies the subframe of 0 in each radio frame, the SIB1-NB message occupies the subframe of 4 in each radio frame, the NPSS occupies the subframe of 5 in each radio frame, and the NSSS occupies the subframe of 9 in each even-numbered radio frame (i.e., the radio frame with its system frame number K a multiple of 2). The scheduling of the system information message SI-1, SI-2, and SI-3 is shown in TABLE 1 below.

TABLE 1

| System | | | |
|---|---|---|---|
| information | | | Transport |
| message | Period | Repetition pattern | block size |
| SI-1 | 64 radio frames | Every 8 radio frames | 552 bits |
| SI-2 | 64 radio frames | Every 16 radio frames | 256 bits |
| SI-3 | 64 radio frames | Every 16 radio frames | 256 bits |

As can be seen from FIG. 4 and TABLE 1, during the radio frame of the system frame number of 0, the network 120 transmits the system information message SI-1 in the subframes (i.e., the subframes of 1-3 and 6-8) unoccupied by the NPBCH, the NPSS, the SIB1-NB message, and the NSSS (which occupy the subframes of 0, 4, 5, and 9, respectively). Because the transport block size of the system information message SI-1 is 552 bits, the number of subframes for transmitting the system information message SI-1 is 8 (NSF=8). Therefore, during the subsequent radio frame of the system frame number of 1, the network 120 continues transmitting the system information message SI-1 in the subframes of 1-2 (because the subframe of 0 is occupied by the NPBCH). Then, during the radio frame of the system frame number of 8, the network 120 transmits the system information message SI-1 in the subframes of 1-3 and 6-8,and during the radio frame of the system frame number of 9, the network 120 transmits the system information message SI-1 in the subframes of 1 and 2.

Afterwards, during the radio frame of the system frame number of 16, the network 120 transmits the system information message SI-2 in the subframes (i.e., the subframes of 1-3 and 6-8) unoccupied by the NPBCH, the NPSS, the SIB1-NB message, and the NSSS (which occupy the subframes of 0, 4, 5, and 9, respectively). Because the transport block size of the system information message SI-2 is 256 bits, the number of subframes for transmitting the system information message SI-2 is 8 (NSF=8). Therefore, during the subsequent radio frame of the system frame number of 1, the network 120 keeps transmitting the system information message SI-2 in the subframes of 1 and 2 (because the subframe of 0 is occupied by the NPBCH).

Then, during the radio frame of the system frame number of 32, the network 120 transmits the system information message SI-3 in the subframes (i.e., the subframes of 1-3 and 6-8) unoccupied by the NPBCH, the NPSS, the SIB1-NB message, and the NSSS (which occupy the subframes of 0, 4, 5, and 9, respectively). Because the transport block size of the system information message SI-3 is 256 bits, the number of subframes for transmitting the system information message SI-3 is 8 (NSF=8). Therefore, during the subsequent radio frame of the system frame number of 33, the network 120 then keeps transmitting the system information message SI-3 in the subframes of 1 and 2 (because the subframe of 0 is occupied by the NPBCH).

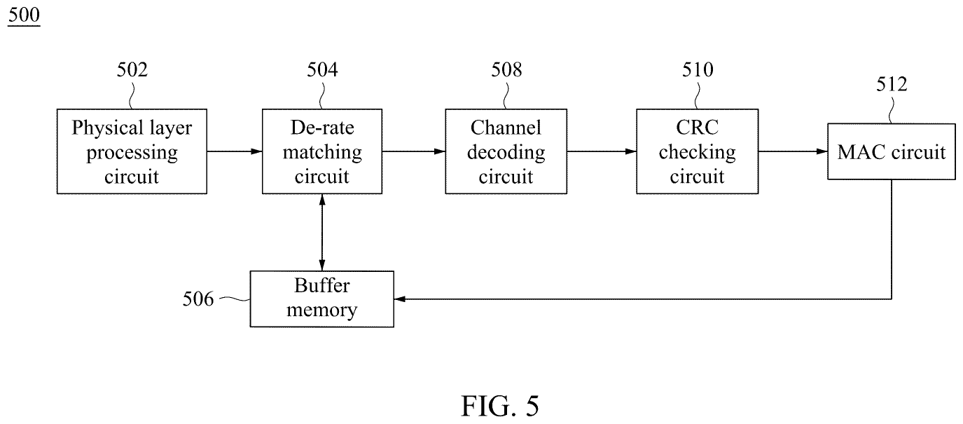

FIG. 5 is a functional block diagram of a wireless communication device 500 in accordance with some embodiments of the present disclosure. The wireless communication device 500 may be, for example, the UE 110 shown in FIGS. 1 and 2, or another wireless communication device that supports NB-IoT communication technology. The wireless communication device 500 includes a physical channel processing circuit 502, a de-rate matching circuit 504, a buffer memory 506, a channel decoding circuit 508, a CRC checking circuit 510, and a media access control (MAC) circuit 512. The physical channel processing circuit 502 is configured to perform front-end processes on received system information messages, which may include functional circuits such as for demodulation, demapping, descrambling, deinterleaving, and/or demultiplexing. The de-rate matching circuit 504 is coupled to the physical channel processing circuit 502 and the buffer memory 506 and is configured to perform a de-rate matching process on the system information messages after the frond-end processes corresponding to the rate matching mode used at the network 120 to generate soft bit sequences, such as filling symbols of zero bit value to recover the punctured bits, and may temporarily store the soft bit sequences into the buffer memory, so as to combine the soft bit sequences temporarily stored in the buffer memory 506 and the soft bit sequences generated by processing the data received again when the data are not successfully received.

The channel decoding circuit 508 is coupled to the de-rate matching circuit 504 and is configured to decode the soft bit sequences to obtain decoded bit sequences. The CRC checking circuit 510 is coupled to the channel decoding circuit 508 and is configured to perform a CRC check on the decoded bit sequences and obtain system information before the CRC attachment at the network after passing the CRC check. The MAC circuit 512 is coupled to the CRC checking circuit 510 and is configured to control radio medium access according to the system information. In addition, the MAC circuit 512 is further coupled to the buffer memory 506 and is configured to divide the buffer memory 506 according to the number of required system information messages, such that the buffer memory 506 includes HARQ buffer blocks, and allocates HARQ processes for the system information messages required by the wireless communication device, so as to receive the system information messages in parallel from a base station in an NB-IoT downlink scheduling period. The allocated HARQ processes respectively correspond to the HARQ buffer blocks. In some embodiments, the sizes of the HARQ buffer blocks are respectively associated with the transport block sizes of the system information messages. For example, if the transport block size of a system information message is 552 bits, according to the system design of the wireless communication device 500, the size of the HARQ buffer block corresponding to the system information message may be a multiple of 552 bits (such as but not limited to 1104 bits or 1656 bits) or 552 bits.

The HARQ buffer blocks mentioned above is used for system information messages using an SI-RNTI. In some embodiments, at least one of the HARQ buffer blocks corresponding to the SI-RNTI is from another HARQ buffer block of the buffer memory 506 for a unicast transmission and/or a random access using a C-RNTI. The transport block size for the C-RNTI may be up to 2536 bits which is a multiple of the maximum transport block size for the SI-RNTI (680 bits), and the HARQ buffer block corresponding to the C-RNTI is used only when the wireless communication device 500 is in the RRC_CONNECTED state, and thus when the wireless communication device 500 is in the RRC_IDLE state, the MAC circuit 512 may divide the HARQ buffer block of the buffer memory 506 corresponding to the C-RNTI into several HARQ buffer blocks for system information message receptions.

The MAC circuit 512 may obtain the number of system information messages received in subsequence from the scheduling information in the SIB1-NB message received from the base station, and may divide the buffer memory 506 into plural HARQ buffer blocks according to the number of system information messages, such that the number of system information messages is identical to the number of HARQ buffer blocks. As such, the de-rate matching circuit 504 may temporarily store the soft bit sequences generated from de-rate matching on the system information messages into the HARQ buffer blocks, respectively.

For example, if the scheduling information in the SIB1-NB message indicates that the system information messages received in subsequence includes a SIB2-NB message, a SIB3-NB message, and a SIB4-NB message, the MAC circuit 512 may divide the buffer memory 506, such that the buffer memory 506 includes 3 HARQ buffer blocks, and allocates 3 HARQ processes for the SIB2-NB message, the SIB3-NB message, and the SIB4-NB message, in which the 3 HARQ processes respectively correspond to the 3 HARQ buffer blocks. Taking the NB-IoT downlink scheduling shown in FIG. 4 as an example, if the system information messages SI-1, SI-2, SI-3 are a SIB2-NB message, a SIB3-NB message, and a SIB4-NB message, respectively, the wireless communication device 500 may receive the SIB2-NB message, the SIB3-NB message, and the SIB4-NB message from the base station in parallel in the same NB-IoT downlink scheduling period. In a configuration of three HARQ buffer blocks, the de-rate matching circuit 504 may temporarily store the soft bit sequences obtained by performing a de-rate matching process on the SIB2-NB message, the SIB3-NB message, and the SIB4-NB message respectively into the corresponding HARQ buffer blocks. If the wireless communication device 500 does not successfully receive the SIB2-NB message, the SIB3-NB message and the SIB4-NB message can still be received from the base station in the same NB-IoT downlink scheduling period without waiting until the SIB2-NB message is successfully received in the subsequent NB-IoT downlink scheduling period. In addition, the de-rate matching circuit 504 may temporarily store the soft bit sequences obtained by performing a de-rate matching process on the SIB3-NB message and the SIB4-NB message respectively into other HARQ buffer blocks without affecting the soft bit sequence temporarily stored into the HARQ buffer block corresponding to the SIB2-NB message.

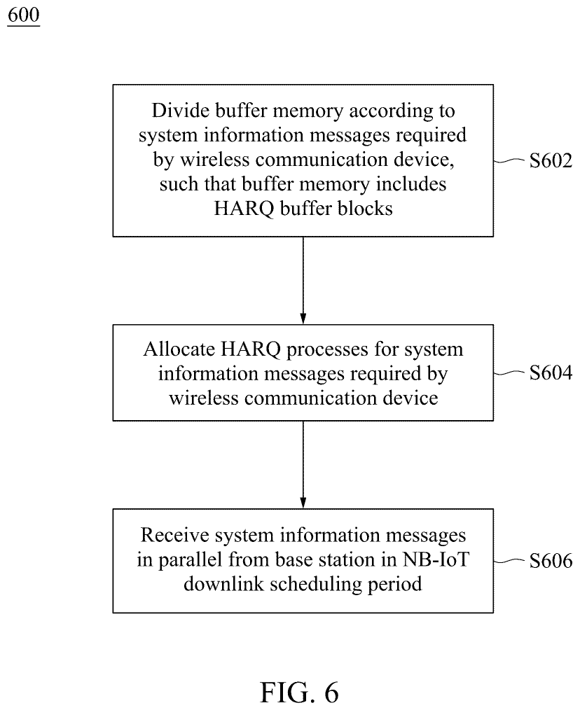

FIG. 6 is a flowchart of a system information message reception method 600 in accordance with some embodiments of the present disclosure. The system information message reception method 600 is applicable to a wireless communication device that supports NB-IoT communication technology, such as the UE 110 in FIGS. 1 and 2, the wireless communication device 500 in FIG. 5, or another suitable wireless communication device. The description for the system information message reception method 600 is as follows. First, Operation S602 is performed to divide a buffer memory of the wireless communication device according to system information messages required by the wireless communication device, such that the buffer memory includes HARQ buffer blocks. Then, Operation S604 is performed to allocate HARQ processes for the system information messages required by the wireless communication device. The HARQ processes respectively correspond to the HARQ buffer blocks. The number of system information messages may be obtained from the scheduling information in the SIB1-NB message, and the number of system information messages is identical to the number of HARQ buffer blocks. Afterwards, Operation S606 is performed to receive the system information messages in parallel from a base station in an NB-IoT downlink scheduling period. The system information message reception method 600 may further include performing a de-rate matching process on the system information messages to generate soft bit sequences and temporarily storing the soft bit sequences respectively into the HARQ buffer blocks.

As can be seen from the above description, according to the implementations of the present disclosure, even if a system information message is not successfully received, the reception of the other system information messages in the same NB-IoT downlink scheduling period will not be affected. Therefore, the implementations of the present disclosure is beneficial for accelerating the time for a user equipment to register a network in an environment such as a weak signal area or where the base station has a large coverage range.

Summarizing the above description, the present disclosure provides a wireless communication device which includes a buffer memory and a MAC circuit. The MAC circuit is coupled to the buffer memory, and is configured to divide the buffer memory according to system information messages required by the wireless communication device such that the buffer memory includes HARQ buffer blocks, and is configured to allocate HARQ processes for the system information messages required by the wireless communication device, so as to receive the system information messages in parallel from a base station in an NB-IoT downlink scheduling period, in which the HARQ processes respectively correspond to the HARQ buffer blocks. In one embodiment, the wireless communication device further includes a de-rate matching circuit that is coupled to the buffer memory and is configured to perform a de-rate matching process on the system information messages to generate soft bit sequences and temporarily store the soft bit sequences into the HARQ buffer blocks, respectively. In one embodiment, sizes of the HARQ buffer blocks are respectively associated with transport block sizes of the system information messages. In one embodiment, at least one of the HARQ buffer blocks originates from another HARQ buffer block of the buffer memory for a unicast transmission or a random access by using a C-RNTI. In one embodiment, the MAC circuit obtains a number of the system information messages from scheduling information in a SIB1-NB message from the base station, and divides the buffer memory into the HARQ buffer blocks according to the number of the system information messages. In one embodiment, the system information messages include a SIB2-NB message. In one embodiment, the system information messages further include at least one of a SIB3-NB message, a SIB4-NB message, a SIB5-NB message, and a SIB22-NB message.

Summarizing the above description, the present disclosure further provides a system information message reception method that is adapted to a wireless communication device and includes: dividing a buffer memory of the wireless communication device according to system information messages required by the wireless communication device, such that the buffer memory includes HARQ buffer blocks; allocating HARQ processes for the system information messages required by the wireless communication device, the HARQ processes respectively corresponding to the HARQ buffer blocks; and receiving the system information messages in parallel from a base station in an NB-IoT downlink scheduling period. In one embodiment, the system information message reception method further includes: performing a de-rate matching process on the system information messages to generate soft bit sequences; and temporarily store the soft bit sequences into the HARQ buffer blocks, respectively. In one embodiment, sizes of the HARQ buffer blocks are respectively associated with transport block sizes of the system information messages. In one embodiment, at least one of the HARQ buffer blocks originates from another HARQ buffer block of the buffer memory for a unicast transmission or a random access by using a C-RNTI. In one embodiment, a number of the system information messages is obtained from scheduling information in a SIB1-NB message, and the number of the system information messages is identical to a number of the HARQ buffer blocks. In one embodiment, the system information messages include a SIB2-NB message. In one embodiment, the system information messages further include at least one of a SIB3-NB message, a SIB4-NB message, a SIB5-NB message, and a SIB22-NB message.

Summarizing the above description, the present disclosure further provides a wireless communication system which includes a base station and a UE. The UE is configured to divide a buffer memory according to required system information messages, such that the buffer memory includes HARQ buffer blocks, and is configured to allocate HARQ processes for the required system information messages, so as to receive the required system information messages in parallel from the base station in an NB-IoT downlink scheduling period, in which the HARQ processes respectively correspond to the HARQ buffer blocks. In one embodiment, sizes of the plurality of HARQ buffer blocks are respectively associated with transport block sizes of the required system information messages. In one embodiment, at least one of the HARQ buffer blocks originates from another HARQ buffer block of the buffer memory for a unicast transmission or a random access by using a C-RNTI. In one embodiment, the UE receives a SIB1-NB message from the base station, and obtains a number of the system information messages from scheduling information in the SIB1-NB message, and divides the buffer memory into the HARQ buffer blocks according to the number of system information messages. In one embodiment, the system information messages include a SIB2-NB message. In one embodiment, the system information messages further include at least one of a SIB3-NB message, a SIB4-NB message, a SIB5-NB message, and a SIB22-NB message.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A wireless communication device, comprising:
a buffer memory; and
a media access control (MAC) circuit coupled to the buffer memory, the MAC circuit configured to divide the buffer memory according to a plurality of system information messages required by the wireless communication device such that the buffer memory comprises a plurality of hybrid automatic repeat request (HARQ) buffer blocks, and configured to allocate a plurality of HARQ processes for the plurality of system information messages required by the wireless communication device, so as to receive the plurality of system information messages in parallel from a base station in a Narrowband Internet of Things (NB-IoT) downlink scheduling period, wherein the plurality of HARQ processes respectively correspond to the plurality of HARQ buffer blocks.

2. The wireless communication device of claim 1, further comprising:
a de-rate matching circuit coupled to the buffer memory, the de-rate matching circuit configured to perform a de-rate matching process on the plurality of system information messages to generate a plurality of soft bit sequences and temporarily store the plurality of soft bit sequences into the plurality of HARQ buffer blocks, respectively.

3. The wireless communication device of claim 1, wherein sizes of the plurality of HARQ buffer blocks are respectively associated with transport block sizes of the plurality of system information messages.

4. The wireless communication device of claim 1, wherein at least one of the plurality of HARQ buffer blocks originates from another HARQ buffer block of the buffer memory for a unicast transmission or a random access by using a cell radio network temporary identifier (C-RNTI).

5. The wireless communication device of claim 1, wherein the MAC circuit obtains a number of the plurality of system information messages from scheduling information in a SIB1-NB message from the base station, and divides the buffer memory into the plurality of HARQ buffer blocks according to the number of the plurality of system information messages.

6. The wireless communication device of claim 1, wherein the plurality of system information messages comprise a SIB2-NB message.

7. The wireless communication device of claim 6, wherein the plurality of system information messages further comprise at least one of a SIB3-NB message, a SIB4-NB message, a SIB5-NB message, and a SIB22-NB message.

8. A system information message reception method adapted to a wireless communication device, the system information message reception method comprising:
dividing a buffer memory of the wireless communication device according to a plurality of system information messages required by the wireless communication device, such that the buffer memory comprises a plurality of HARQ buffer blocks;
allocating a plurality of HARQ processes for the plurality of system information messages required by the wireless communication device, the plurality of HARQ processes respectively corresponding to the plurality of HARQ buffer blocks; and
receiving the plurality of system information messages in parallel from a base station in an NB-IoT downlink scheduling period.

9. The system information message reception method of claim 8, further comprising:
performing a de-rate matching process on the plurality of system information messages to generate a plurality of soft bit sequences; and
temporarily store the plurality of soft bit sequences into the plurality of HARQ buffer blocks, respectively.

10. The system information message reception method of claim 8, wherein sizes of the plurality of HARQ buffer blocks are respectively associated with transport block sizes of the plurality of system information messages.

11. The system information message reception method of claim 8, wherein at least one of the plurality of HARQ buffer blocks originates from another HARQ buffer block of the buffer memory for a unicast transmission or a random access by using a C-RNTI.

12. The system information message reception method of claim 8, wherein a number of the plurality of system information messages is obtained from scheduling information in a SIB1-NB message, and the number of the plurality of system information messages is identical to a number of the plurality of HARQ buffer blocks.

13. The system information message reception method of claim 8, wherein the plurality of system information messages comprise a SIB2-NB message.

14. The system information message reception method of claim 13, wherein the plurality of system information messages further comprise at least one of a SIB3-NB message, a SIB4-NB message, a SIB5-NB message, and a SIB22-NB message.

15. A wireless communication system, comprising:
a base station; and
a user equipment (UE) configured to divide a buffer memory according to a plurality of required system information messages, such that the buffer memory comprises a plurality of HARQ buffer blocks, and configured to allocate a plurality of HARQ processes for the plurality of required system information messages, so as to receive the plurality of required system information messages in parallel from the base station in an NB-IoT downlink scheduling period, wherein the plurality of HARQ processes respectively correspond to the plurality of HARQ buffer blocks.

16. The wireless communication system of claim 15, wherein sizes of the plurality of HARQ buffer blocks are respectively associated with transport block sizes of the plurality of required system information messages.

17. The wireless communication system of claim 15, wherein at least one of the plurality of HARQ buffer blocks originates from another HARQ buffer block of the buffer memory for a unicast transmission or a random access by using a C-RNTI.

18. The wireless communication system of claim 15, wherein the UE receives a SIB1-NB message from the base station, and obtains a number of the plurality of required system information messages from scheduling information in the SIB1-NB message, and divides the buffer memory into the plurality of HARQ buffer blocks according to the number of the plurality of required system information messages.

19. The wireless communication system of claim 15, wherein the plurality of required system information messages comprise a SIB2-NB message.

20. The wireless communication system of claim 19, wherein the plurality of required system information messages further comprise at least one of a SIB3-NB message, a SIB4-NB message, a SIB5-NB message, and a SIB22-NB message.
